(19) United States
(12) Patent Application Publication
(10) Pub. No.: US 2026/0135248 A1
(43) Pub. Date: May 14, 2026

(54) PURGE SYSTEM ASSOCIATED WITH BATTERY SYSTEM

(71) Applicant: Caterpillar Inc., Peoria, IL (US)

(72) Inventors: Narayanaswamy Kudithipati, Bangalore (IN); Xugang Zhang, Peoria, IL (US); Murali Krishnan Raghupathy, Bangalore (IN)

(73) Assignee: Caterpillar Inc., Peoria, IL (US)

(21) Appl. No.: 18/940,912

(22) Filed: Nov. 8, 2024

(51) Int. Cl. H01M 50/383; H01M 50/317; H01M 50/367

(52) U.S. Cl. CPC H01M 50/383; H01M 50/317; H01M 50/367

(57) ABSTRACT

PURGE SYSTEM ASSOCIATED WITH BATTERY SYSTEM

A purge system associated with a battery system including at least one battery module. The purge system includes a reservoir that stores a suppression agent and a conduit assembly in fluid communication with the at least one battery module and the reservoir. The conduit assembly includes at least one conduit in fluid communication with the reservoir and the at least one battery module. The purge system further includes at least one valve. Upon actuation, the at least one valve supplies the suppression agent from the reservoir towards the at least one battery module via the conduit assembly to purge thermal runaway gases exiting the at least one battery module. The purge system further includes at least one deflector. The at least one deflector receives the suppression agent upon actuation of the at least one valve.

### TECHNICAL FIELD

The present disclosure relates to a battery system, a purge system associated with the battery system, and a method for purging thermal runaway gases in the battery system.

### BACKGROUND

Battery systems are being used in a variety of applications as a means of power supply. For example, battery systems are being increasingly implemented in passenger vehicles, construction machines, and the like, to provide power supply. Such battery systems include multiple battery modules that may be packaged in any configuration, based on desired applications.

Generally, the battery modules include high-energy density volatile battery cells to store electrical power and distribute the stored electrical power. The number of battery cells may be arranged adjacent to each other in the battery module. In some instances, one or more battery cells of the battery module may experience a thermal event, such as overheating, fire propagation, or thermal runaway. Such thermal events may result in a release of thermal runaway gases. Thermal runaway gases may vent out and propagate to other surrounding battery modules. In some examples, other battery modules may also experience thermal events, which may produce thermal runaway gases. These gases are toxic in nature and may accumulate in a battery compartment, which is not desirable.

DE102022104368 describes a motor vehicle with an energy storage device and an extinguishing device for supplying an extinguishing agent to the energy storage system, wherein the extinguishing device has a first extinguishing agent line into which an extinguishing agent can be discharged, and which leads at least to the energy storage device, which has at least one battery cell which has a cell housing and a releasable first battery cell arranged in the cell housing degassing opening, from which a gas can be led out of the cell housing in the event of a thermal continuity of the battery cell. The first extinguishing agent line is connected to the releasable first degassing opening of the battery cell, so that when the first degassing port is released and in the event that an extinguishing agent is fed into the first extinguishing agent line, the extinguishing agent can be introduced into the cell housing via the first extinguishing agent line through the released first degassing opening.

### SUMMARY OF THE DISCLOSURE

In an aspect of the present disclosure, a purge system for a battery system is provided. The battery system includes at least one battery module. The purge system includes a reservoir that stores a suppression agent. The purge system also includes a conduit assembly in fluid communication with the at least one battery module and the reservoir. The conduit assembly includes at least one conduit. The at least one conduit is in fluid communication with the reservoir and the at least one battery module. The at least one conduit defines a conduit end that is disposed proximal to the at least one battery module. The purge system further includes at least one valve. The at least one conduit is in fluid communication with the at least one valve. The at least one valve is disposed at the conduit end of the at least one conduit. Upon actuation, the at least one valve supplies the suppression agent from the reservoir towards the at least one battery module via the conduit assembly to purge thermal runaway gases exiting the at least one battery module. The purge system includes at least one deflector. The at least one deflector is coupled to the at least one battery module. The at least one deflector is disposed proximal to the conduit end of the at least one conduit. The at least one deflector receives the suppression agent upon actuation of the at least one valve.

In another aspect of the present disclosure, a battery system is provided. The battery system includes at least one battery module. The at least one battery module includes a vent that discharges thermal runaway gases generated during a thermal event in the at least one battery module. The battery system also includes a purge system for the at least one battery module. The purge system includes a reservoir that stores a suppression agent. The purge system also includes a conduit assembly in fluid communication with the at least one battery module and the reservoir. The conduit assembly includes at least one conduit. The at least one conduit is in fluid communication with the reservoir and the at least one battery module. The at least one conduit defines a conduit end that is disposed proximal to the at least one battery module. The purge system further includes at least one valve. The at least one conduit is in fluid communication with the at least one valve. The at least one valve is disposed at the conduit end of the at least one conduit. Upon actuation, the at least one valve supplies the suppression agent from the reservoir towards the at least one battery module via the conduit assembly to purge thermal runaway gases exiting the at least one battery module. The purge system includes at least one deflector. The at least one deflector is coupled to the at least one battery module. The at least one deflector is disposed in proximity to the conduit end of the at least one conduit. The at least one deflector receives the suppression agent upon actuation of the at least one valve.

In yet another aspect of the present disclosure, a method for purging thermal runaway gases in a battery system is provided. The battery system includes at least one battery module. The method includes coupling a purge system with the at least one battery module. The purge system includes a reservoir that stores a suppression agent. The purge system also includes a conduit assembly in fluid communication with the at least one battery module and the reservoir. The conduit assembly includes at least one conduit. The at least one conduit is in fluid communication with the reservoir and the at least one battery module. The at least one conduit defines a conduit end that is disposed proximal to the at least one battery module. The purge system further includes at least one valve. The at least one conduit is in fluid communication with the at least one valve. The at least one valve is disposed at the conduit end of the at least one conduit. The purge system includes at least one deflector. The at least one deflector is coupled to the at least one battery module. The at least one deflector is disposed proximal to the conduit end of the corresponding conduit from the at least one conduit. The method also includes actuating the at least one valve by thermal runaway gases exiting the at least one battery module. The method further includes supplying, via the conduit assembly, the suppression agent from the reservoir towards the at least one battery module based on actuation of the at least one valve. The method includes receiving, by the at least one deflector, the suppression agent via the conduit assembly. The method also includes purging thermal runaway gases exiting the at least one battery module based on an interaction of the suppression agent with thermal runaway gases.

Other features and aspects of this disclosure will be apparent from the following description and the accompanying drawings.

### BRIEF DESCRIPTION OF THE DRAWINGS

FIG. 1 is a schematic front view of a battery system including a purge system, according to an example of the present disclosure;

FIG. 2 is a schematic side view of the battery system of FIG. 1;

FIG. 3 is a schematic cross-sectional view of a deflector of the purge system of FIG. 1, according to an example of the present disclosure;

FIG. 4 is a schematic cross-sectional view of a deflector associated with the purge system of FIGS. 1 to 3, according to another example of the present disclosure;

FIG. 5 illustrates an exemplary arrangement of a reservoir for the purge system of FIGS. 1 to 3, according to an example of the present disclosure; and

FIG. 6 is a flowchart of a method for purging thermal runaway gases in the battery system of FIGS. 1 to 3, according to an example of the present disclosure.

### DETAILED DESCRIPTION

Wherever possible, the same reference numbers will be used throughout the drawings to refer to the same or like parts.

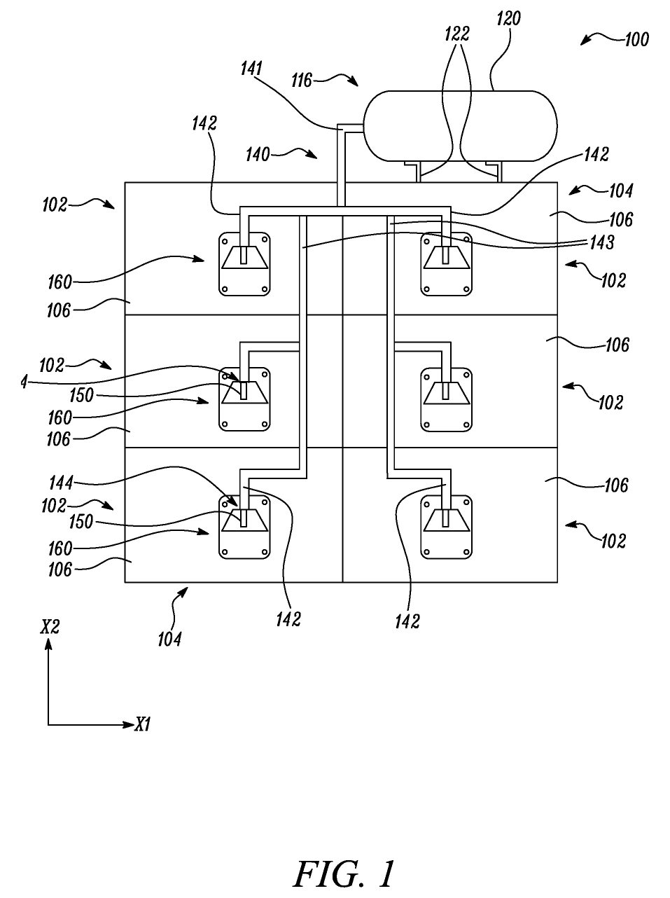

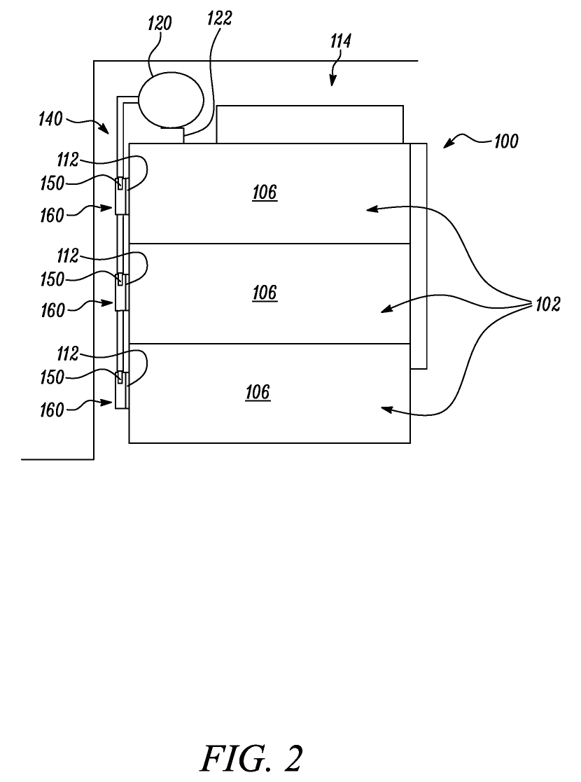

Referring to FIG. 1, a schematic front view of a battery system 100 is illustrated, according to an example of the present disclosure. The battery system 100 may be used in a variety of applications as a means of power supply. For example, the battery system 100 may be used in a machine, a passenger vehicle, and the like, to provide power supply to one or more components associated therewith. The machine may include a moving machine or a stationary machine. The machine may include a work machine or a construction machine, such as, a mining truck, a wheel loader, and the like. The battery system 100 is disposed in a battery compartment 114 (shown in FIG. 2) of the machine.

The battery system 100 includes one or more battery module 102. In the illustrated example of FIG. 1, the battery system 100 includes a number of battery modules 102. The battery system 100 includes a pair of battery stacks 104 disposed adjacent to each other along a horizontal axis X1. Each battery stack 104 from the pair of battery stack 104 includes three battery modules 102 that are arranged in a stacked relationship along a vertical axis X2 of the battery system 100. The number of battery modules 102 are electrically coupled together to provide a desired amount of power output and voltage output. In the illustrated example of FIG. 1, six battery modules 102 are illustrated. However, the battery system 100 may include any number of battery modules 102 that may be stacked in any type of arrangement, based on application requirements. In an example, the battery system 100 may include a single battery module 102.

The one or more battery modules 102 include a housing 106. In the illustrated example of FIG. 1, the housing 106 is rectangular in shape. In other examples, the housing 106 may have a square shape. In some examples, the housing 106 may be made of aluminum, composites, plastics, and/or any other suitable material.

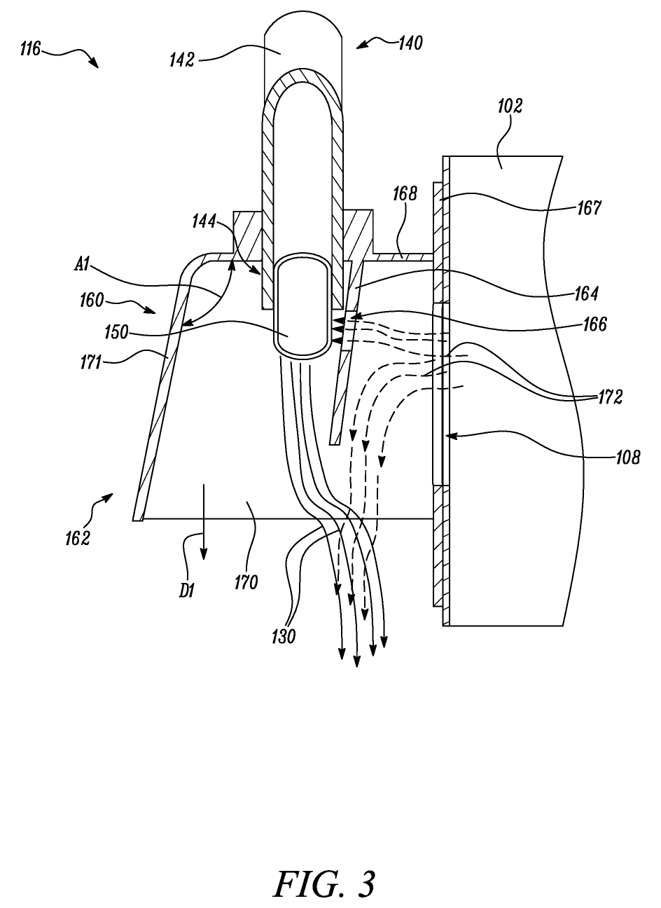

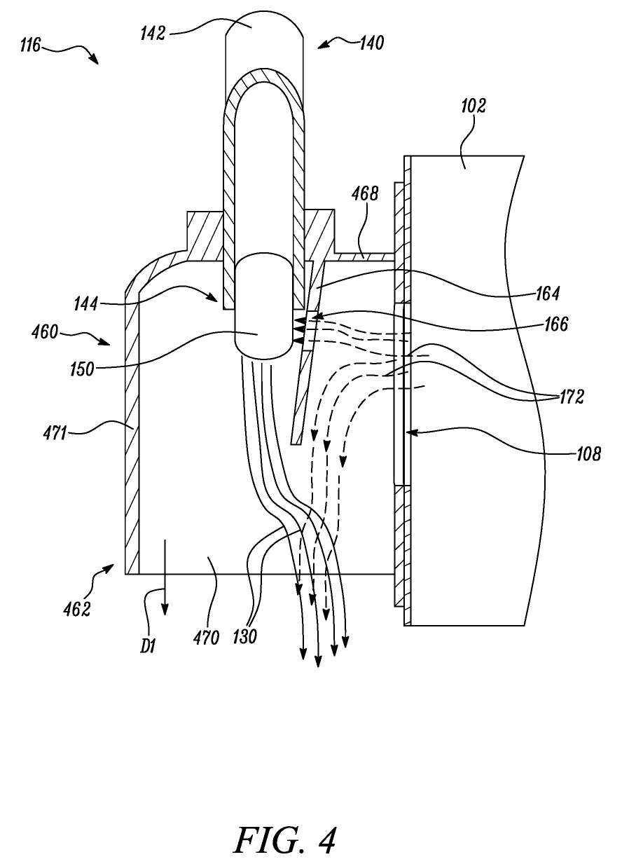

The one or more battery modules 102 include a vent 108 that discharges thermal runaway gases 172 (shown in FIGS. 3 and 4) generated during a thermal event in the one or more battery modules 102. Specifically, each of the number of battery modules 102 includes the vent 108 that discharges thermal runaway gases 172 generated during the thermal event in the corresponding battery module 102. The vent 108 is an outlet for thermal runaway gases 172 that may be generated during thermal event in the corresponding battery module 102. The vent 108 directs thermal runaway gases 172 towards atmosphere.

Each of the number of battery modules 102 includes a number of battery cells (not shown) disposed within the housing 106. The battery cells may include prismatic cells, for example. However, the battery cells may include other form factors i.e., cylindrical, pouch, blade cells, etc. and may incorporate any type of cell chemistry. The battery cells may incorporate, for example, a lithium-ion battery technology to store electrical power and distribute the stored electrical power at a battery module voltage and a battery module amperage. It should be noted that the power distribution and power storage characteristics of each battery module 102 may be defined at least in part based on the configurations of the number of battery cells included in the corresponding battery module 102. In other examples, the battery module 102 may embody any other type of battery technology/cell chemistry, such as, a lead-acid battery technology, nickel metal hydride battery technology, and the like that converts chemical energy directly to electrical energy by utilizing a difference in bond energies of the compounds utilized in the construction of the battery module 102. Further, the battery cells may include any capacity, voltage, energy, etc.

FIG. 2 is a schematic side view of the battery system 100 of FIG. 1. The one or more battery modules 102 further include a burst disc 112 coupled to the housing 106. Specifically, each battery module 102 includes the burst disc 112 coupled to the housing 106. The burst disc 112 encloses the vent 108 (see FIG. 1) of the battery module 102. The burst disc 112 may dislodge from the corresponding battery module 102 when a pressure within the corresponding battery module 102 exceeds a predefined pressure value. In other words, during thermal event in the battery cells, a large amount of thermal runaway gases 172 (see FIGS. 3 and 4) may be generated inside the corresponding battery module 102 that may increase the pressure inside the corresponding battery module 102. The pressure generated by thermal runaway gases 172 may dislodge the burst disc 112 from the corresponding battery module 102.

Referring to FIGS. 1 and 2, the battery system 100 includes a purge system 116. The present disclosure relates to the purge system 116 associated with the battery system 100. The purge system 116 includes a reservoir 120 that stores a suppression agent 130. In the arrangement shown in FIGS. 1 and 2, the reservoir 120 is disposed on top of the battery modules 102. The reservoir 120 may be coupled with the battery modules 102 at top walls of the housing 106 of the battery modules 102. The reservoir 120 may include any shape or size, as per requirements. The size of the reservoir 120 may be based on a required volume of the suppression agent 130 and/or a size of the battery system 100.

The purge system 116 includes a reservoir support 122. The reservoir support 122 connects the reservoir 120 with the top battery modules 102, and also supports the reservoir 120 on the battery modules 102. It should be noted that the reservoir 120 may be disposed at any location on the battery system 100 based on the space availability. Further, in some examples, the reservoir 120 may be placed at any location on the machine, without limiting the scope of the present disclosure. In such examples, the purge system 116 may include a tube assembly that may be routed towards the one or more battery modules 102 from the reservoir 120. Further, the present disclosure is not limited by an orientation or a location of the reservoir 120. In some examples, the suppression agent 130 includes an inert gas or an aerosol. The suppression agent 130 may include argon, nitrogen, helium, or carbon dioxide. It should be noted that the present disclosure is not limited to a type of the suppression agent 130.

Referring to FIG. 1, the purge system 116 includes a conduit assembly 140 in fluid communication with the one or more battery modules 102 and the reservoir 120. The conduit assembly 140 includes one or more conduits 142. In the illustrated embodiment of FIG. 1, the conduit assembly 140 includes six conduits 142 associated with a corresponding battery module 102 from the six battery modules 102. However, the conduit assembly 140 may include any number of conduits 142, without any limitations. Further, a number of conduits 142 may be based on the number of battery modules 102. The one or more conduits 142 is in fluid communication with the reservoir 120 and the one or more battery modules 102. In other words, each conduit 142 from the number of conduits 142 is in fluid communication with the reservoir 120 and the corresponding battery module 102 from the number of battery modules 102. The conduit assembly 140 also includes a common conduit 141 and conduits 143 that together supply the suppression agent 130 from the reservoir 120 to the corresponding conduit 142. Further, the one or more conduits 142 defines a conduit end 144 that is disposed proximal to the one or more battery modules 102. Specifically, each conduit 142 from the number of conduits 142 defines a conduit end 144 that is disposed proximal to the corresponding battery module 102 from the number of battery modules 102. The conduit ends 144 is disposed proximal to the vent 108 of the corresponding battery module 102.

The purge system 116 further includes one or more valves 150. In some examples, the one or more valves 150 is a thermally actuated valve. In some examples, the one or more valves 150 is a hot-blow gas bulb type valve. The one or more conduits 142 is in fluid communication with the one or more valves 150. Specifically, each conduit 142 from the number of conduits 142 is in fluid communication with a corresponding valve 150 from the number of valves 150. Further, the one or more valves 150 are disposed at the conduit end 144 of the one or more conduits 142. In other words, each valve 150 from the number of valves 150 is disposed at the conduit end 144 of a corresponding conduit 142 from the number of conduits 142. In some examples, the valve 150 is at least partially disposed within the conduit 142.

The purge system 116 further includes one or more deflectors 160. The one or more deflectors 160 are coupled to the one or more battery modules 102. Specifically, each deflector 160 from the number of deflectors 160 is coupled to the corresponding battery module 102 from the number of battery modules 102. Further, the one or more deflectors 160 are disposed proximal to the conduit end 144 of the one or more conduits 142. In other words, each deflector 160 from the number of deflectors 160 is disposed proximal to the conduit end 144 of the corresponding conduit 142 from the number of conduits 142.

Referring to FIG. 3, a schematic cross-sectional view of a portion of the purge system 116 is illustrated. However, only one deflector 160 and only one battery module 102 is shown with their respective components herein as an example. The one or more deflectors 160 enclose a corresponding vent 108 of the one or more battery modules 102. As shown in FIG. 3, each deflector 160 from the number of deflectors 160 encloses a corresponding vent 108 of the corresponding battery module 102. vent 108.

The one or more deflectors 160 include a body 162 that, at least partially, receives the one or more valves 150 and the one or more conduits 142 therein. Specifically, each deflector 160 from the number of deflectors 160 includes a body 162 that, at least partially, receives the corresponding valve 150 and the corresponding conduit 142 therein. The body 162 includes a base plate 167 that allows coupling of the deflector 160 with the corresponding battery module 102. The base plate 167 includes through-openings (not shown) to receive a number of fasteners (not shown). The fasteners couple the deflector 160 with the corresponding battery module 102, and may include bolts, screws, pins, and the like.

The body 162 also includes a top wall 168 and a number of sidewalls 170, 171 that are angularly disposed relative to the top wall 168. The sidewalls 170, 171 extend in a downward direction D1 from the top wall 168. The body 162 includes two sidewalls 170, only one of which is shown herein. The two sidewalls 170 are orthogonal to the top wall 168. However, the sidewall 171 is disposed angularly relative to the top wall 168. In an example, the top wall 168 and the sidewall 171 define an included angle A1. The included angle A1 is an oblique angle herein. The included angle A1 is greater than 90 degrees herein. The one or more deflectors 160 direct the suppression agent 130 supplied by the one or more valves 150 in the downward direction D1. Specifically, each deflector 160 from the number of deflectors 160 directs the suppression agent 130 supplied by the corresponding valve 150 in the downward direction D1. Specifically, the number of sidewalls 170, 171 provide a guiding path to direct the suppression agent 130 in the downward direction D1, which allows purging of thermal runaway gases 172.

The one or more deflectors 160 further include a deflecting member 164 disposed within the body 162 of the deflector 160. Specifically, each deflector 160 from the number of deflectors 160 further includes a deflecting member 164 disposed within the body 162 of the deflector 160. The deflecting member 164 is disposed in front of the vent 108. During a release of thermal runaway gases 172 from the battery module 102, the deflecting member 164 directs thermal runaway gases 172 in the downward direction D1. The deflecting member 164 includes an opening 166 through which a portion of thermal runaway gases 172 is directed towards the one or more valves 150 for actuating the one or more valves 150. Specifically, the deflecting member 164 includes the opening 166 through which the portion of thermal runaway gases 172 are directed towards the corresponding valve 150 for actuating the corresponding valve 150. It should be noted that the deflector 160 may include any other shape to serve the intended function. Further, the deflector 160 may be made of thermally protective materials. In some examples, the deflector 160 may be made of aluminum, steel, brass, mica-based materials, fiber-reinforced materials, or any polymer that has a high melting point, without any limitations.

In an example, when the battery module 102 experiences thermal event, thermal runaway gases 172 generate enough pressure to dislodge the burst disc 112 (see FIG. 2), thereby causing thermal runaway gases 172 to exit the corresponding battery module 102 via the vent 108. Thermal runaway gases 172 exiting the corresponding battery module 102 actuates the corresponding valve 150 from the number of valves 150 to supply the suppression agent 130 from the reservoir 120 towards the corresponding battery module 102. Further, upon actuation, each valve 150 supplies the suppression agent 130 from the reservoir 120 towards the corresponding battery module 102 via the conduit assembly 140 to purge thermal runaway gases 172 exiting the corresponding battery module 102. Furthermore, each deflector 160 receives the suppression agent 130 upon actuation of the corresponding valve 150 from the number of valves 150. The suppression agent 130 is directed in the downward direction D1 by the deflector 160. Moreover, the deflecting member 164 deflects a majority portion of thermal runaway gases 172 in the downward direction D1, which causes interaction of thermal runaway gases 172 with the suppression agent 130, thereby purging thermal runaway gases 172 by the suppression agent 130.

Referring now to FIG. 4, another design of a deflector 460 that may be associated with the purge system 116 of FIGS. 1 and 2 is illustrated. The deflector 460 is substantially similar to the deflector 160 shown in FIG. 3 with common components referred to by the same numerals. The deflector 460 includes a body 462 that, at least partially, receives the corresponding valve 150 and the corresponding conduit 142 therein. The body 462 includes a top wall 468 and a number of sidewalls 470, 471 that are angularly disposed relative to the top wall 468. The body 462 includes two sidewalls 470, only one of which is shown herein. Each of the sidewalls 470, 471 are orthogonal to the top wall 468. Each deflector 160 from the number of deflectors 160 directs the suppression agent 130 supplied by the corresponding valve 150 in the downward direction D1. Specifically, the sidewalls 470, 471 provide a guiding path to direct the suppression agent 130 in the downward direction D1, which allows purging of thermal runaway gases 172.

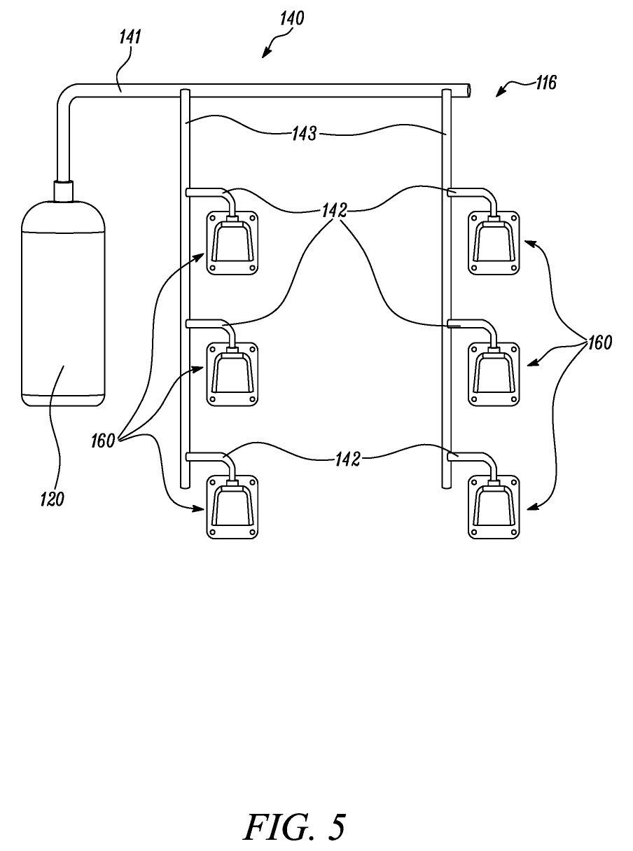

FIG. 5 illustrates another arrangement of the reservoir 120 of the purge system 116. In this arrangement, the reservoir 120 is disposed sideways relative to the conduit assembly 140. In other words, the reservoir 120 may be coupled to sidewalls of the battery modules 102 (see FIG. 1). The reservoir supports 122 (see FIG. 1) or any similar structure may be used to couple the reservoir 120 with the battery modules 102. Alternatively, the reservoir 120 can be placed at any location on the machine, without any limitations.

It may be noted that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure as defined in the appended claims.

### INDUSTRIAL APPLICABILITY

The present disclosure is related to the purge system 116 associated with the battery system 100. The purge system 116 includes the reservoir 120 that stores the suppression agent 130. The purge system 116 also includes the number of valves 150 that are triggered based on the release of thermal runaway gases 172 from the battery modules 102. Upon actuation, each valve 150 supplies the suppression agent 130 from the reservoir 120 towards the corresponding battery module 102 via the conduit assembly 140 to purge thermal runaway gases 172 exiting the corresponding battery module 102. In other words, the purge system 116 activates only when the corresponding battery module 102 experiences thermal event and operates to dispense the suppression agent 130 for a longer period, thereby providing operator or occupants with sufficient time to move out of the machine. The suppression agent 130 may include the inert gas or the aerosol which may have no effects on the components of the battery system 100, as it does not cause cross-reactions with the components of the battery system 100.

The purge system 116 may quickly purge and force out thermal runaway gases 172 away from the battery system 100. The rapid purging of thermal runaway gases 172 does not allow thermal runaway gases 172 to spread across other portions of the battery system 100 or other components surrounding the battery system 100. The purge system 116 may also prevent accumulation of thermal runaway gases 172 within the battery compartment 114 and may also allow cooling of thermal runaway gases 172 below an auto ignition temperature while the suppression agent 130 is being dispensed from the reservoir 120. This may help in rapid extinguishing of thermal runaway gases 172 and mitigation of thermal events, may prevent damage to other battery modules 102 or the machine, and may also provide sufficient time for operators or passengers to move out of the machine.

The purge system 116 includes the number of deflectors 160. Each deflector 160 receives the suppression agent 130 upon actuation of the corresponding valve 150 from the number of valves 150. The number of deflectors 160 allow contact of the suppression agent 130 and thermal runaway gases 172 for rapid purging of thermal runaway gases 172.

The purge system 116 may be simple in construction, may be cost-effective, and may be durable. The purge system 116 may be used on a variety of machines/battery system configurations and may be retrofitted on existing battery systems. Further, application of the purge system 116 may not be limited to the battery system 100 and may be also used for other systems such as, but not limited to, an electrical circuitry proximal to a component carrying an energy dense element. Moreover, components such as the conduits 142, the valves 150, the deflectors 160, and the like may be made of materials that can withstand high temperature of thermal runaway gases 172 for a certain time period. In an example, the components may withstand high temperatures for a time period that is equal to or more than 3 minutes.

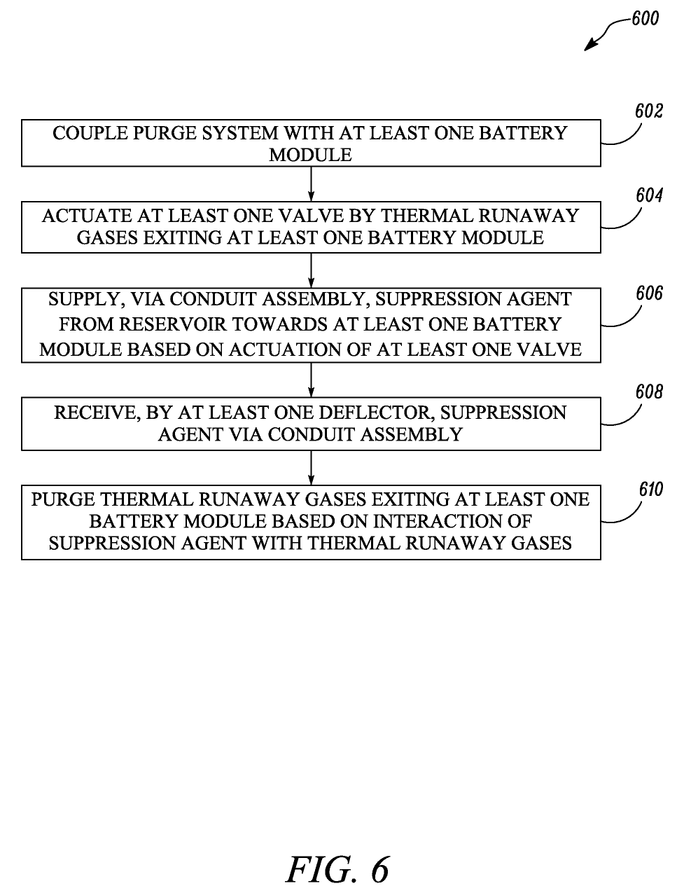

FIG. 6 is a flowchart for a method 600 for purging thermal runaway gases 172 in the battery system 100. The battery system 100 includes the one or more battery modules 102. With reference to FIGS. 1 to 3 and FIG. 6, at step 602, the purge system 116 is coupled with the one or more battery modules 102. At step 604, the one or more valves 150 are actuated by thermal runaway gases 172 exiting the one or more battery modules 102. Moreover, at the step 604, the portion of thermal runaway gases 172 are directed towards the one or more valves 150 via the opening 166 in the deflecting member 164 of the one or more deflectors 160.

At step 606, the conduit assembly 140 supplies the suppression agent 130 from the reservoir 120 towards the one or more battery modules 102 based on actuation of the one or more valves 150.

At step 608, the suppression agent 130 is received by the one or more deflectors 160, via the conduit assembly 140.

At step 610, thermal runaway gases 172 exiting the one or more battery modules 102 are purged based on the interaction of the suppression agent 130 with thermal runaway gases 172.

The method 600 further includes a step (not shown) at which the one or more deflectors 160 direct the suppression agent 130 being received via the conduit assembly 140 in the downward direction D1.

Further, the one or more battery modules 102 include the vent 108 that discharges thermal runaway gases 172 generated during thermal event in the one or more battery modules 102. The method 600 further includes a step (not shown) at which thermal runaway gases 172 exiting the one or more battery modules 102 actuate the one or more valves 150 to supply the suppression agent 130 from the reservoir 120 towards the one or more battery modules 102.

Referring to FIGS. 3, 4, and 6, the one or more deflectors 160, 460 include the body 162, 462 that, at least partially, receives the one or more valves 150 and the portion of the corresponding conduit 142 therein. The body 162, 462 includes the top wall 168, 468 and the number of sidewalls 170, 171, 470, 471 that are angularly disposed relative to the top wall 168, 468. The deflector 160, 460 also includes the deflecting member 164 disposed within the body 162, 462 of the deflector 160, 460. The deflecting member 164 is disposed in front of the vent 108. The method 600 further includes a step (not shown) at which thermal runaway gases 172 are directed in the downward direction D1 by the deflecting member 164 of the one or more deflectors 160, 460.

While aspects of the present disclosure have been particularly shown and described with reference to the embodiments above, it will be understood by those skilled in the art that various additional embodiments may be contemplated by the modification of the disclosed purge system, battery system and method steps without departing from the spirit and scope of the disclosure. Such embodiments should be understood to fall within the scope of the present disclosure as determined based upon the claims and any equivalents thereof.

What is claimed is:

1. A purge system associated with a battery system, the battery system including at least one battery module, the purge system comprising:
a reservoir that stores a suppression agent;
a conduit assembly in fluid communication with the at least one battery module and the reservoir, wherein the conduit assembly includes at least one conduit, wherein the at least one conduit is in fluid communication with the reservoir and the at least one battery module, and wherein the at least one conduit defines a conduit end that is disposed proximal to the at least one battery module;
at least one valve, wherein the at least one conduit is in fluid communication with the at least one valve, wherein the at least one valve is disposed at the conduit end of the at least one conduit, and wherein, upon actuation, the at least one valve supplies the suppression agent from the reservoir towards the at least one battery module via the conduit assembly to purge thermal runaway gases exiting the at least one battery module; and
at least one deflector, wherein the at least one deflector is coupled to the at least one battery module, wherein the at least one deflector is disposed proximal to the conduit end of the at least one conduit; and wherein the at least one deflector receives the suppression agent upon actuation of the at least one valve.

2. The purge system of claim 1, wherein the at least one battery module includes a vent that discharges thermal runaway gases generated during a thermal event in the at least one battery module, and wherein thermal runaway gases exiting the at least one battery module actuate the at least one valve to supply the suppression agent from the reservoir towards the at least one battery module.

3. The purge system of claim 2, wherein the at least one deflector encloses a corresponding vent of the at least one battery module.

4. The purge system of claim 2, wherein the at least one deflector includes:
a body that, at least partially, receives the at least one valve and the at least one conduit therein, wherein the body includes a top wall and sidewalls that are angularly disposed relative to the top wall; and
a deflecting member disposed within the body of the deflector, wherein the deflecting member is disposed in front of the vent, wherein the deflecting member is adapted to direct thermal runaway gases in a downward direction, and wherein the deflecting member includes an opening through which a portion of thermal runaway gases are directed towards the at least one valve for actuating the at least one valve.

5. The purge system of claim 4, wherein the at least one deflector is adapted to direct the suppression agent being supplied by the at least one valve in the downward direction.

6. The purge system of claim 1, wherein the suppression agent includes an inert gas or an aerosol.

7. The purge system of claim 1, wherein the at least one valve is a thermally actuated valve.

8. The purge system of claim 7, wherein the at least one valve is a hot-blow gas bulb type valve.

9. A battery system comprising:
at least one battery module, wherein the at least one battery module includes a vent that discharges thermal runaway gases generated during a thermal event in the at least one battery module; and
a purge system for the at least one battery module, the purge system including:
a reservoir that stores a suppression agent;
a conduit assembly in fluid communication with the at least one battery module and the reservoir, wherein the conduit assembly includes at least one conduit, wherein the at least one conduit is in fluid communication with the reservoir and the at least one battery module, and wherein the at least one conduit defines a conduit end that is disposed proximal to the at least one battery module;
at least one valve, wherein the at least one conduit is in fluid communication with the at least one valve, wherein the at least one valve is disposed at the conduit end of the at least one conduit, and wherein, upon actuation, the at least one valve supplies the suppression agent from the reservoir towards the at least one battery module via the conduit assembly to purge thermal runaway gases exiting the at least one battery module; and
at least one deflector, wherein the at least one deflector is coupled to the at least one battery module, wherein the at least one deflector is disposed proximal to the conduit end of the at least one conduit; and wherein the at least one deflector receives the suppression agent upon actuation of the at least one valve.

10. The battery system of claim 9, wherein thermal runaway gases exiting the at least one battery module actuate the at least one valve to supply the suppression agent from the reservoir towards the at least one battery module.

11. The battery system of claim 9, wherein the at least one deflector encloses a corresponding vent of the at least one battery module.

12. The battery system of claim 9, wherein the at least one deflector includes:
a body that, at least partially, receives the at least one valve and the at least one conduit therein, wherein the body includes a top wall and sidewalls that are angularly disposed relative to the top wall; and
a deflecting member disposed within the body of the deflector, wherein the deflecting member is disposed in front of the vent, wherein the deflecting member is adapted to direct thermal runaway gases in a downward direction, and wherein the deflecting member includes an opening through which a portion of thermal runaway gases are directed towards the at least one valve for actuating the at least one valve.

13. The battery system of claim 12, wherein the at least one deflector is adapted to direct the suppression agent being supplied by the at least one valve in the downward direction.

14. The battery system of claim 9, wherein the suppression agent includes an inert gas or an aerosol.

15. The battery system of claim 9, wherein the at least one valve is a thermally actuated valve.

16. A method for purging thermal runaway gases in a battery system, the battery system including at least one battery module, the method comprising:
coupling a purge system with the at least one battery module, wherein the purge system includes:
a reservoir that stores a suppression agent;
a conduit assembly in fluid communication with the at least one battery module and the reservoir, wherein the conduit assembly includes at least one conduit, wherein the at least one conduit is in fluid communication with the reservoir and the at least one battery module, and wherein the at least one conduit defines a conduit end that is disposed proximal to the at least one battery module;
at least one valve, wherein the at least one conduit is in fluid communication with the at least one valve, and wherein the at least one valve is disposed at the conduit end of the at least one conduit; and
at least one deflector, wherein the at least one deflector is coupled to the at least one battery module, and wherein the at least one deflector is disposed proximal to the conduit end of the at least one conduit;
actuating the at least one valve by thermal runaway gases exiting the at least one battery module;
supplying, via the conduit assembly, the suppression agent from the reservoir towards the at least one battery module based on actuation of the at least one valve;
receiving, by the at least one deflector, the suppression agent via the conduit assembly; and
purging thermal runaway gases exiting the at least one battery module based on an interaction of the suppression agent with thermal runaway gases.

17. The method of claim 16 further comprising directing, by the at least one deflector, the suppression agent being received via the conduit assembly in a downward direction.

18. The method of claim 16, wherein the at least one battery module includes a vent that discharges thermal runaway gases generated during a thermal event in the at least one battery module, the method further comprising:
actuating, by thermal runaway gases exiting the at least one battery module, the at least one valve to supply the suppression agent from the reservoir towards the at least one battery module.

19. The method of claim 18, wherein the at least one deflector includes a body that, at least partially, receives the at least one valve and the at least one conduit therein and a deflecting member disposed within the body of the deflector, and wherein the deflecting member is disposed in front of the vent, the method further comprising:
directing, by the deflecting member of the at least one deflector, thermal runaway gases in a downward direction.

20. The method of claim 19, wherein the step of actuating the at least one valve further includes directing, via an opening in the deflecting member of the at least one deflector, a portion of thermal runaway gases towards the at least one valve.
